(19) United States
(12) Patent Application Publication
(10) Pub. No.: US 2023/0316344 A1
(43) Pub. Date: Oct. 5, 2023

(54) SYSTEMS AND METHODS FOR ENHANCING THE EFFICIENCY OF INITIATING, CONDUCTING AND FUNDING RESEARCH PROJECTS

(71) Applicant: Collavidence Inc., Calgary (CA)

(72) Inventors: Mayank GOYAL, Calgary (CA); Rosalie MCDONOUGH, Calgary (CA); Arnuv MAYANK, Calgary (CA); Aravind GANESHY, Calgary (CA); Johanna OSPEL, Calgary (CA); Alex LEMNARU, Calgary (CA)

(73) Assignee: Collavidence Inc., Calgary (CA)

(21) Appl. No.: 18/193,001

(22) Filed: Mar. 30, 2023

Related U.S. Application Data
(60) Provisional application No. 63/326,027, filed on Mar. 31, 2022.

(51) Int. Cl. G06Q 30/0279; G06Q 10/10

(52) U.S. Cl. CPC G06Q 30/0279; G06Q 10/103

(57) ABSTRACT

Systems and methods to enhance the efficiency of initiating, conducting and funding research projects are described. The system includes a plurality of attributes relevant to users of the system including donors, potential donors, researchers and research projects. The system utilizes matching strategies to present research projects to donors that may best align with the donor's interests as defined by their attributes. The system includes negative and serendipitous strategies to also present research projects to donors that are not necessarily aligned with the donor's interests as defined by their attributes.

### RELATED APPLICATIONS

This nonprovisional U.S. patent application claims the benefit of priority of U.S. Provisional Patent Application No. 63/326,027, filed Mar. 31, 2022, listing Mayank GOYAL as the first inventor and Collavidence Inc. as the applicant. The entire contents of the above-referenced application and of all priority documents referenced in the Application Data Sheet filed herewith are hereby incorporated by reference for all purposes.

### FIELD

Systems and methods to enhance the efficiency of initiating, conducting and funding research projects are described. The system includes a plurality of attributes relevant to users of the system including donors, potential donors, researchers and research projects. The system utilizes matching strategies to present research projects to donors that may best align with the donor's interests as defined by their attributes. The system includes negative and serendipitous strategies to also present research projects to donors that are not necessarily aligned with the donor's interests as defined by their attributes.

### BACKGROUND

It is well known that medical research undertaken to evaluate new treatments, drugs and/or medical devices, moves forward through a combination of basic research (for example, lab research that involves cell culture and animal experiments) and clinical trials (for example, research that involves human participants). Typically, following successful basic research, a researcher or team of researchers will initiate and undertake clinical research in order to evaluate the results of the basic research to prove the safety of the treatment, drug, and/or medical device in humans.

As is known and generally speaking, the stages of clinical medical research include a) observation of a particular pattern from a dataset that may have been collected and maintained over a period of time, b) establishing a hypothesis, c) designing a study, typically either a retrospective (for example, a case series study) or a prospective (for example, a cohort study) study and d) the use of data that are obtained to make further observations. In the case of a new treatment, once there is accumulation of sufficient data and relative maturity of technology and/or medications, human trials are undertaken.

In the case of medical research that is seeking to prove the safety of a treatment, drug, and/or medical device, such research will require that the clinical research is completed in stages, typically classified into phases (for example, Food and Drug Administration (FDA) trial phases I, II and III) depending on whether the required work is early in the clinical research or relatively late in the research. Typically, Phase I trials are done in healthy volunteers to demonstrate safety, Phase II trials are done in patients to demonstrate feasibility and effect size and finally, and Phase III studies are done in patients that are usually randomized controlled trials where the new treatment is tested head-to-head against the currently existing standard of care to demonstrate benefit to patients.

Most clinical medical research studies are multi-centric meaning that more than one medical facility is involved and that can involve the participation of multiple teams, researchers, physicians, and patients. Such studies have multiple advantages including faster accumulation of information, especially for rare conditions, a greater degree of generalizability, robustness and overall greater credibility of the research. It is however also well known that undertaking and completing such trials requires substantial time and money.

In most cases, the process of receiving the money required to undertake both basic medical research and clinical medical research (clinical trials) involves one or more researchers writing various research grant applications to funding agencies. Many of these funding agencies are government agencies that utilize tax dollars to fund the research. One example in the United States in the National Institutes of Health (NIH). Other countries have similar national research funding agencies.

Alternatively, or in combination, private companies such as the company that manufactures a drug or device funds the medical research and/or medical trial (“industry funding”).

Still further, philanthropic agencies, such as the Bill and Melinda Gates foundation, may also fund research that may be of particular interest to that foundation.

The process of initiating medical research (both basic and clinical) is slow for multiple reasons. Sometimes it is so slow that, by the time a research grant has been approved, the study that it was supposed to be used for is already outdated because newer and better treatment options for that particular disease have become available. Some of the reasons that slow down the funding process are outlined below.

Generally, the demand for funding by researchers far outstrips the available supply of public and private funds for the research. This means that more often than not, a research grant application is rejected at the first submission, and multiple submissions are required until the application is eventually successful, leading to a substantial time delay. Moreover, the general trend of the competitiveness for funding continues to increase.

As shown in FIG. 1, the process for obtaining research funding through funding agencies is a complex process of application, review and funding. These will often include fixed dates for submission (often only twice per year), complex submission formats and a slow evaluation process (often several months).

In a typical scenario, researchers 10 submit research proposals to a funding body 10a. The funding body 10a allocates the various applications to subject matter specific committees 10b comprised of experts/reviewers 10c in the subject matter area who are tasked with reviewing the various proposals for acceptance or rejection. Typically, each reviewer 10c will be required to review a significant number of proposals in isolation 10d and make their recommendations to the committee who will then collectively decide which proposals to accept and reject. The review process has many problems and inefficiencies, some of which are outlined below.

For example, the reviewing process is typically a condensed and intensive process where the experts after receiving a number of proposals for review, may be required travel to a central location where they may spend several days discussing and approving or denying proposals. Reviewers are usually academic peers volunteering their free time and performing the reviews besides their daily work, which may lead to time delays. Some agencies may also have a multi-step review process that requires additional input or clarification on proposals which can result in months-long delays.

Importantly, while the grant reviewers are typically experts within their specific field, given the complexity of the various fields of research including medicine in general, they may not precisely have the expertise in the exact topic of a particular grant.

Under typical circumstances, the time from the submission of the first grant application to the grant being accepted is very often more than 2 years. Moreover, subsequent to a grant being approved, there are often various complexities related to budgets, and release of monies that can delay and/or affect the start of a research project.

Still further, for industry funded trials there are several additional considerations. For example, a company will primarily assign research funding to trials that, if successful, would increase the sales of the particular drug/device in question. If a business case cannot be made by the researchers, it is quite difficult to obtain industry funding.

Research that is heavily funded by industry may be perceived as biased by the public, and researchers who run industry-funded trials may under some circumstances risk their credibility. There is also data to suggest that industry-sponsored clinical medical research is indeed often biased towards favoring the new drug or device being tested.

Furthermore, clinical trials that test treatments from which no revenue can be generated by industry, for example simple treatments such as daily exercise, physiotherapy or cold compresses, will not receive industry funding. In other words, industry funding will neglect simple, cheap treatments and often favor more expensive drugs and medical procedures.

In addition, company/industry sponsored trials are often designed and conducted in such a way that if successful, the research results in FDA approval of a particular device or drug. Any involvement of the FDA adds further complexity to the process.

Other implications of a slow and/or inefficient research process relates to the effect on the business case for the research. Generally, innovation is guided by the ‘business case’ and the overall costs of taking an idea to approval, sale and revenue generation. The longer and more time consuming this process is, the lower the motivation for innovators, venture capital, etc.

Rising costs are also a significant factor in affecting business decisions around undertaking research. Ultimately, the company manufacturing a drug/device must make profit for the industry model to be sustainable. The longer the whole process takes, the higher the cost of the drug or device will be after it is approved.

Public and philanthropic funding have been essential to the advancement of medicine and healthcare, with funding through the industry growing to over US$140B. However, funding is dominated by large organizations that succumb to all the inefficiencies described herein. Indeed, the ten largest fund organizations together funded approximately US$37.1B, or 40%, of all public and philanthropic health research in the United States in 2013 (Viergever, Roderik & Hendriks, Thom. (2016) “The 10 largest public and philanthropic funders of health research in the world: What they fund and how they distribute their funds” Health Research Policy and Systems. 14. 10.1186/s12961-015-0074-z).

Importantly, the source of these funds is from the taxpayer, so in essence the average citizen is the ultimate donor to medical research. Increasingly, the average taxpayer wants more transparency and control over how their money is used. Thus, there is a need for a new way for potential donors to donate to medical research projects directly, without the need for a large organization including government agencies as the intermediary.

Importantly, the average individual or family donor is motivated to donate/support research for different reasons than government or industry with personal experiences being a key motivating factor. In addition, there are other motivations and expectations of smaller donors when making decisions to make donations to support research.

One trend is towards customization in the manufacture and delivery of goods and services. The phenomenon of customization influences every industry, from coffee to clothes to cars. Even with large scale manufacturing, mass production has made way for mass customization, and the pursuit of customization and customer-oriented practices has led to innovative solutions. With philanthropy, and especially philanthropy towards medical research, the need for customization is even higher, as donors often have a strong emotional attachment to certain diseases, conditions, or other topics within medicine. For example, a potential donor may have a loved one who suffered from a giant wide-necked posterior inferior cerebellar artery (PICA) aneurysm, and when that occurred was surprised to learn that there was a paucity of natural history data and a lack of consensus regarding treatment strategies. The potential donor may have been surprised to learn that this type of aneurysm is relatively rare (0.5-3% of aneurysms), there has not been sufficient dedicated research for significant advancement, and for large organizations, funding for research for this condition is not deemed worthwhile. Thus, after learning about the condition, the potential donor may subsequently look to directly donate to a research team that looks to specifically work on treating the PICA aneurysm.

On a broader scale, there has been a growing outcry against large granting agencies such as the NIH for more transparency and control over how their taxpayer-derived and private money is used. Those who have an experience such as the above have naturally questioned the authority of an organization such as the NIH to decide what research is important and what is not. Additionally, with grant reviewers often having a bias for well-established, seasoned researchers with certain personal attributes (race, gender, etc.) and other factors including politics, donors have perceived the current funding process to be an unfair use of their money and wish to take direct control. This is not to say that they wish for there to be an absence of bias in the funding decision-making process; rather, they wish for their money to tailor to their own personal biases. For example, a potential donor from Uzbekistan may wish to increase the reputability of the Uzbekistani research, so they may seek to specifically fund research that is led by an Uzbekistani team.

Another trend seen from donors is that they wish for medical research to be conducted not for the sake of proving effectiveness for industry leaders, but for the sake of betterment of humanity and society. Very often from a patient point of view and/or from a clinical medical research point of view, the more important question is whether a particular procedure (as opposed to a particular device, which is only a small part of the entire procedure) is beneficial. While these two goals may often overlap, donors often wish for the priority to be for the betterment of society. Generally, the FDA wants ‘pure’ data related to a particular device before granting approval. This is desirable in some respects to the extent that one does not want to mix the results of two disparate drugs and devices and grant approval to both. However, on the other hand, if the results of the two are quite similar, one does not want to delay the whole approval process just because the individual companies lack sufficient commitment and/or resources to do only one drug/device trial. This is ultimately important to the extent that the patient may not necessarily care. For example, when performing a surgery for colon cancer, the patient and researcher is interested in whether the surgery as a whole is beneficial to the patient, not in whether a particular scalpel is better than another scalpel. Donors may look for research projects that explore or prioritize the patient experience, and, again, the attribute is unfeasible for large organizations to look at.

With these behavioral trends, it is logical to think that a potential donor may look to bypass the large organizations and instead donate to research projects on their own. However, there are several virtually insurmountable barriers for an individual potential donor; accordingly, there is a need for systems that can assist smaller donors in directing their donations to projects that they are personally interested in.

Firstly, a donor has no easy way of searching for projects. There is no central broad-based database of medical research projects that can be accessed by the public. Further, there are no systems that provide the opportunity for a combination of traditional funding and donor-centric funding. Further, as it is currently the norm for researchers to seek funding from granting agencies, a potential donor will find it especially difficult to find a research proposal that is looking for funding outside of the regular streams of cash.

Moreover, even if such a central hub existed for medical research proposals and review, it would be unfeasible for a donor to search through the thousands of project proposals and find which project best suits their criteria of an ideal proposal. Further, an average donor does not have the necessary expertise to judge the merits of a proposal, but only how interesting the ideas are to them. Accordingly, without a dedicated solution, they may end up funding proposals that have no chance of coming to fruition in a meaningful way. Further still, even if a donor had the time and energy to search through all of these proposals and believed that they found the perfect proposal, the reality is that there is likely another project that they would find more preferable, because it is very difficult for a donor to know what is truly important to them, and they may have some hidden biases that they cannot uncover on their own.

Thus, there is a need for a platform that amalgamates medical research proposals and review, where donors are, through the help of an algorithm, recommended the projects that are most likely to fit donors' desires of an ideal project, at which point donors can donate however much they desire to projects in a crowdfunding model. While this recommendation system has some basic similarities to recommendation systems used by Netflix or YouTube, the problem is different and more complicated for a medical research donor. Unlike the aforementioned platforms, where there is a one-to-one connection between the user and the content they consume, the medical research platform needs to understand many more factors about the donor, the researcher(s), and the proposal to make the best possible recommendation.

Furthermore, algorithms employed by Netflix and YouTube have much more data with which to work, which is not the case for the medical research platform. Looking at precedent from the current mainstream crowdfunding platforms, such as GoFundMe, Kickstarter, or experiment.com, the vast majority of donors only donate once on the site, with there being very few repeat backers. Additionally, a crowdfunding-based research platform will have far fewer project proposals than YouTube has videos or Netflix has movies/shows. Thus, the algorithm will need to find ways of bootstrapping data and recommendations in a way that utilizes the trends listed above.

Another particular issue is the tendency for recommendation algorithms to promote an “echo chamber.” That is, for a given user, many of these recommendation algorithms use past behavior of both the user and other similar users to construct a recommendation, and, eventually, this group of individuals get stuck with only the same type of content that is reinforced in a positive feedback loop. This problem is especially impactful for medical research; unlike Facebook, whose motivation to solve this problem is to increase engagement on its platform, the field of medical research requires innovation to progress, and if many ideas are getting ignored due to an echo chamber, then it is to the detriment of all of society. Additionally, and importantly, the problem of an echo chamber is one that currently exists in the medical research world, independent of an algorithm. As shown in FIG. 1, during the funding process, funding agencies, their committees and reviews often bring various biases to the process that favor well-established, seasoned researchers, wherein new researchers are forced to adopt their thinking/proposals/approaches to those of the seasoned researchers' ideas in order to obtain research grant money at the start of their careers to enable them to build up a reputation.

From the perspective of a potential donor, it is in their best interest to have exposure to the most ideas possible, so they can get a holistic view of their funding options and choose the proposal that best matches their interests, which, as mentioned in the behavioral trends, is of increasing importance.

### SUMMARY

Generally, systems and methods to enhance the efficiency of initiating, conducting and funding research projects are described. Using a plurality of attributes relevant to users of the system including donors, potential donors, researchers and research projects, the system utilizes matching strategies to present research projects to donors that may best align with the donor's interests as defined by their attributes. The system includes negative and serendipitous strategies to also present research projects to donors that are not necessarily aligned with the donor's interests as defined by their attributes and based on the behaviors of past donors, updates user and researcher attributes to present projects to donor's that are more likely to result in a donation by the user.

In a first aspect, a system for matching user attributes of registered users of a database to projects within the database wherein each project has project attributes is described, comprising: a non-transitory computer readable medium encoded with instructions to perform the following steps:
A1—defining a registered user record with a plurality of user attributes including explicit user attributes and at least one implicit user attribute within a user database;
A2—defining projects with a plurality of project attributes within a project database;
via a website interface and upon a registered user accessing the website interface to examine projects within the database
B1—conducting a matching search between explicit user attributes and project attributes to create a listing of projects having a best correlation of explicit user attributes and project attributes; and,
C1—displaying a list of projects from step B1 to the user via the website.

In one embodiment, the system further includes step D1—enabling a registered user to select a project and make a financial contribution to support a specific project and wherein upon making a financial contribution to the specific project, at least one implicit attribute of a user is updated based on the specific project selected and the project attributes of the specific project.

In one embodiment, when a plurality of registered users having each made at least one financial contribution to a project in the past, the system defines the plurality of registered users having each made at least one financial contribution to a project in the past as past donors, and the system, based on financial contributions made and project attributes, determines for the past donors, projects having a greater likelihood of eliciting a donation based on past activity of the past donors and projects having a lower likelihood of eliciting a financial contribution based on past activity of the past donors.

In another embodiment, at least one project having a lower likelihood of eliciting a financial contribution is displayed to a user at step C1.

In another embodiment, the system includes step B1A—identifying at least one project having at least one randomly selected project attribute that is not aligned with a registered user's attributes for display to a user at step C1.

In another embodiment, the system includes step A3—defining a registered researcher record with a plurality of researcher attributes including explicit researcher attributes.

In another embodiment, the system includes step E1—enabling a registered user to select a project and make a financial contribution to support a specific project and wherein upon making a financial contribution to the specific project, updating a researcher's explicit attributes based on the specific project selected and the registered user attributes.

### BRIEF DESCRIPTION OF THE DRAWINGS

Various embodiments are described with reference to the drawings in which:

FIG. 1 is a schematic overview of a typical funding process as may currently be followed.

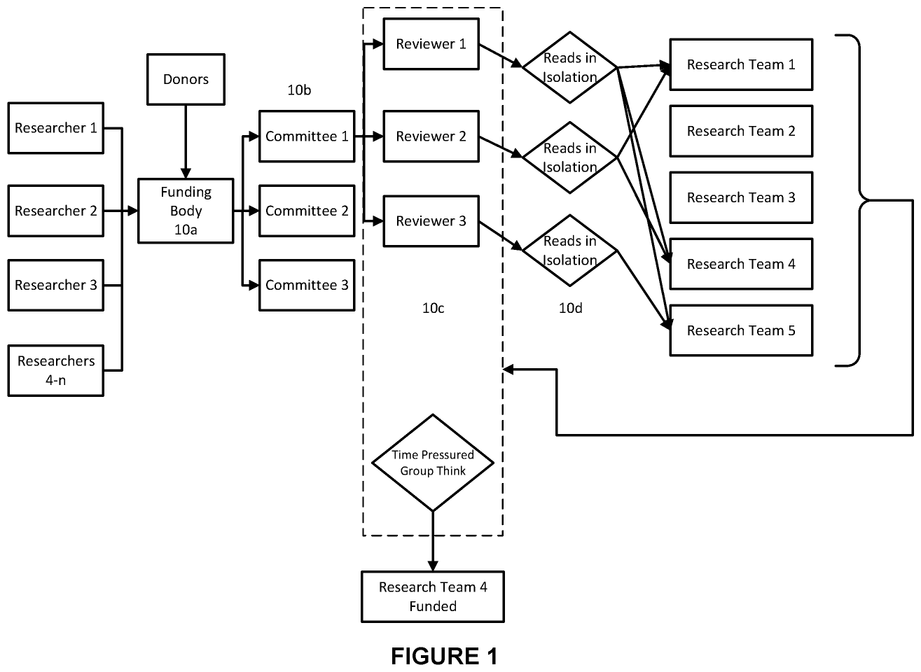

FIG. 2 is a schematic diagram showing an overview of the interaction between donors and researchers in accordance with one embodiment.

FIG. 3 is a schematic diagram showing the steps by which a potential donor (PD) may initially interact with the system.

FIG. 4 is a schematic diagram showing the steps by which a potential donor (PD) may initially interact with the system and be presented with a list of research projects of interest in accordance with one embodiment.

FIG. 5 is a schematic diagram showing how clusters of projects having positively matched, negatively-matched and serendipitously-matched attributes may be presented to a PD in accordance with one embodiment.

FIG. 6 is a logic flow diagram illustrating how attributes may be updated in accordance with one embodiment.

### DETAILED DESCRIPTION

With reference to the Figures, systems and methods for optimizing donor experience in funding research including medical research are described. This application is related to the Applicant's co-pending patent application, U.S. 63/302,362 entitled “Systems and Methods to Improve Efficiency of Collaboration to Define and Establish Research Projects” and incorporated herein by reference.

The system is implemented as a web-based platform with a plurality of users, each having defined, but not mutually exclusive roles. These roles are as follows:
a medical researcher 20a;
potential donors who may be defined as:
   large donors 20b such as institutional donors; and,
   smaller donors 20c such as a layperson who may be interested in medical research.

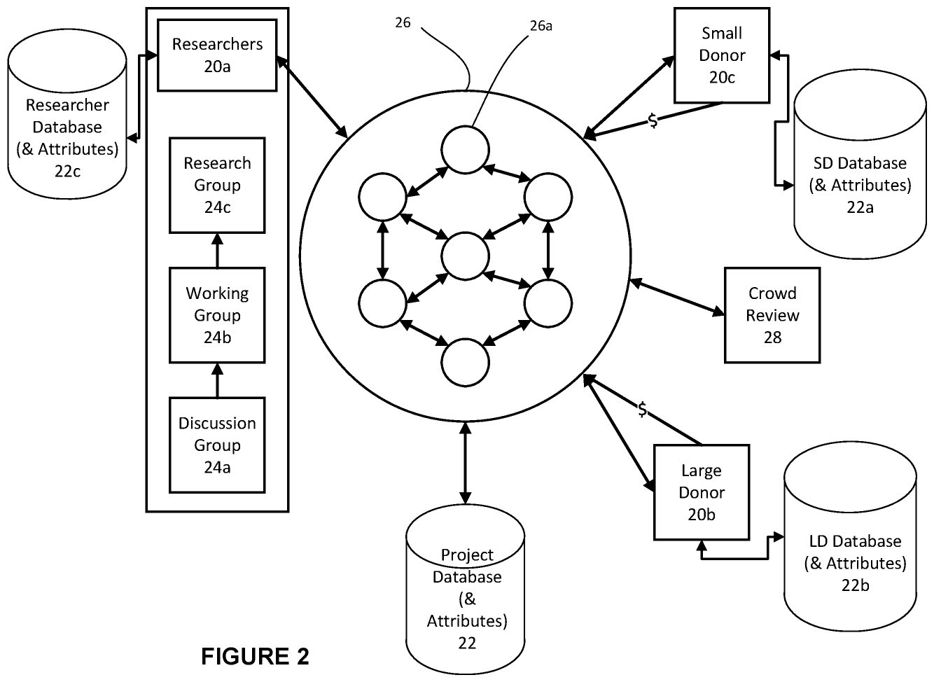

Each of these users can generally access and register with the website and thereafter have access to different projects 22 within the website database as shown in FIG. 2 and as described in greater detail below.

As shown in FIG. 2, and as described in Applicant's co-pending application, the system and its website generally allow researchers to establish and define research projects that includes defining funding requirements for the research project. Establishing a research project involves a multi-step process including establishing a discussion group 24a, a working group 24b and ultimately a research group 24c. Upon creation of a research group, defining a funding requirement and publishing the research project on the website 26 as open for donation, donor users can access the website 26 and its various pages 26a and in accordance with the disclosure be presented with projects that are determined as being aligned with the donors' interests. The website will typically interact with a project database 22 in which details of various projects and their attributes are stored, a small donor database 22a with details of small donors and their attributes, a large donor database 22b with details of large donors and their attributes and a researcher database 22c with details of researchers and their attributes. The precise deployment of the system may be undertaken in a variety of ways with the preceding description merely illustrating a logical separation of different aspects of the overall system.

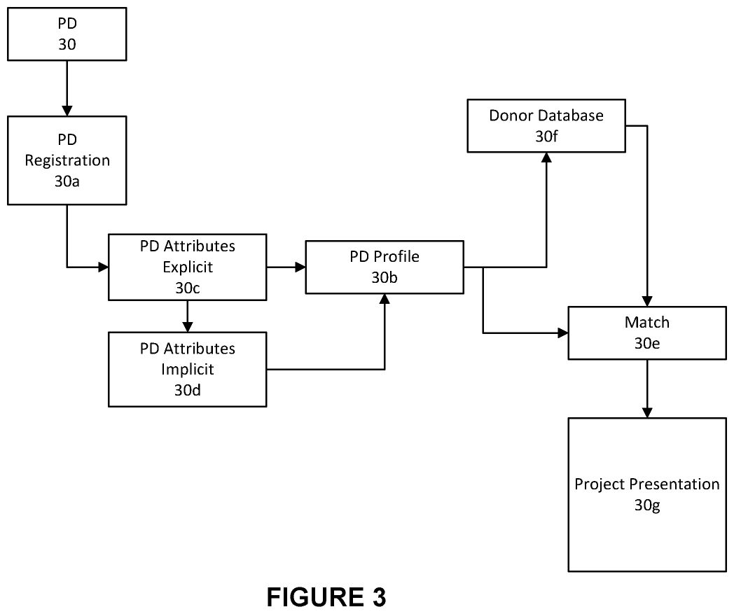

As shown in FIG. 3, each donor 30 (referred to herein generally as a potential donor (PD) when no donation has been made or as a donor when a donation has been made; although these terms at least partially overlap with one another) will register 30a and create a profile 30b with the system. In a typical embodiment, the potential donor is prompted with how they would like to use the system such as a large donor or as a small donor. As explained below, various attributes can be further refined where donors may be further characterized as a casual donor or as a precision donor.

PDs will generally input various identifying information including basic identifying information. After defining themselves as a category of donor, the PD will enter various additional data that is used to establish a PD profile including a variety of factors that can be used to match a PD to projects that may be of greatest interest to the PD. As described below, establishing a PD profile may include obtaining from the PD information through data entry and questions/statements that obtain from the PD a wide range of information that can be used by the system to understand the background and interests of the PD. As shown in Table 1, such donor representative categories of attributes and attributes of a PD and donor may be characterized as follows:

TABLE 1
Representative Donor Attribute Categories, Attributes and Sub-Attributes

| | Attribute Category | Attribute | Sub-Attributes |
|---|---|---|---|
| 1 | Basic Donor | Location | many |
| | Identification | Age | |
| | | Sex | |
| | | Net Worth | |
| | | Donation Size/Range | |
| | | Profession | |
| | | Experience | |
| | | Family Health History | |
| 2 | Donor Type | Large | |
| | | Small | |
| | | Casual | |
| | | Precision | |
| 3 | Social Interests | Basic Human Health | many |
| | | Children | |
| | | Education | |
| | | Physical Health | |
| | | Mental Health | |
| 4 | Donor Motivation | Personal Experience | many |
| | | Professional Experience | |
| | | Personal Interests | |
| | | Foundation Mandate | |
| 5 | Donor Values | Human equality | many |
| | | Diversity | |
| 6 | Research Interests | Basic Research | many |
| | | Applied Research | |
| 7 | Other Motivations | Interest in Reviewing Projects | many |
| | | Wealth Deployment | |
| | | Diversity | |
| | | Young Researchers | |
| | | Geographical | |
| | | Institutional Support (e.g. | |
| | | university/hospital/etc. | |
| 8 | User Defined Attribute | New Attribute defined by user | many |

Each of the attribute categories and attributes may be designed to include a wide-range of categories and specific attributes that may be further refined with a wide-range of sub-attributes. For example, research interests as an attribute category may include attributes of basic research and applied research. Sub-attributes of basic research could include basic medical research, basic engineering research, basic chemical research, etc.

The definition of attribute categories, attributes, and sub-attributes will develop over time and become more refined and/or complex as the number of users of the system grows and new attributes are developed and introduced which can include attributes specifically defined by users of the system.

The process by which a PD registers and inputs their attributes may be presented/obtained in range of formats including filling in defined fields and/or asking interview type questions or obtaining statements from the PD. For example, and in no particular order, a PD may be prompted to answer yes or no to the various questions when the system is obtaining information about certain motivating factors. Such questions may be presented in a logical and hierarchical format based on previous answers or data already entered. Example questions may be in the form and/or structured as outlined below.
I am interested in donating and don't mind in what area or to what project my money is deployed
I identify as being interested in funding specific projects that closely align with my values and motivations
I am interested in reviewing projects and providing input.
I am primarily interested in Basic Human Physical Health
   I value physical exercise as a means of advancing human physical health
I am primarily interested in Basic Human Mental Health
Personal/Loved Ones Experience(s)
   I am interested in donating because I have a personal experience with a medical issue. I have personally experienced/my loved one(s) have experienced:
      Stroke
      Heart Disease
      Cancer
      Parkinson's
Wealth deployment
   I am interested in deploying my wealth for the betterment of humankind.
   I want my money deployed for the purposes of supporting researchers within my country/region.
   I would like to support younger researchers.
Specific Technology Areas/Multi-disciplinary research
   I am interested in:
      Robotics
      Rehabilitation

A large donor may similarly be asked to further identify their motivation(s) to donate and/or their values which may be helpful later to determine which projects may best align with personal or institutional objectives. For example, additional categories of questions/information may be asked/sought including:
Large Donor Motivation
   Foundation Mandate
      How is the foundation mandate defined?
   Defined Technical Area
Primary technical area(s) of interest

PDs and donors would have the option to alter their profile at any point after creating their profile and/or may be asked to periodically update their profiles. In one embodiment, the system may periodically prompt users to answer random and/or targeted questions as a means to routinely engage donors with the system and allow the system to update/improve the system's understanding of the donor's attributes. For example, after registration, the system may send an email to all PDs and donors that specifically follows up the donor asking them the reasons that they may have made a donation. In addition, the system may periodically ask questions or make a statement and seek the donor's input to those questions/statements that can directly or indirectly be used to learn more about the donor. Representative questions/statements are:
Basic medical research accounts for 30% of all medical research conducted and on average takes 10 years to see direct human benefit from such research. I would like to see more basic medical research be conducted. Yes/No
The drug XYZ recently received Phase III approval for use in the treatment of X. I would like to see further research conducted to determine the efficacy of this drug for the treatment of other cancers. Yes/No

Further, as defined and explained below, such questions may enable the system to update a user's attributes and specifically, determine if implicit attributes should be updated to be characterized as explicit attributes.

Accordingly, as described above, regardless of the specific questions that have been asked, a plurality of donor attributes will have been collected where such information is stored within appropriate small/large donor databases 22a,22b.

Researchers will also input information as described in Applicant's co-pending application including the following general information after a principal investigator (PI) or a number of co-PIs have defined/established the research project. This will typically include the background of the research, the purpose of the research, the methods used to evaluate the research, a detailed budget with the necessary funds to conduct the research, a corresponding timeline of the estimated completion of certain milestones, other needs including additional expertise, multimedia for the purposes of attracting attention, and PI and research group member profiles/attributes including track records, vision, etc.

Upon successful submission of a research proposal, the proposal and its attributes would be stored in a project database 22 and the researchers and their attributes would be stored in the researcher database 22c. When appropriate criteria have been met, the project would be live on the website 26 for all users to see and interact with via the website 26.

As shown in FIG. 2, if a user were to click on a research project 26a as displayed on the website, they would be able view all of the information that the research group entered (shown in FIG. 2 as a web of interconnected webpages 16a) and would have various ways of interacting with the research proposal that generally fall into different categories of interaction including crowd review, casual funding and precision funding.

The opportunity to fund a project may be presented to potential donors in a number of ways including what may be defined as precision funding and casual funding. Precision funding generally entails efficiently presenting to a potential donor a number of projects that may closely align with their interests/values as determined by the donor's attributes. Importantly, the ability to match is undertaken to increase the donor's motivation to engage with the system to ensure that the donor is efficiently directed to projects they are most likely to donate to and are not searching through projects around which they have little or no interest and/or do not meet the criteria they may be obligated to follow to meet their responsibilities as may be the case for larger donors. By efficiently presented information to donors, the likelihood of projects being funded is increased.

### Matching Projects to Donors

While in various embodiments, all research proposals/projects (projects/proposals being used interchangeably herein) are potentially viewable to all users in the system, the large number of available projects and the range of diversity of such projects, effectively matching donors to projects that meet their requirements is difficult.

That is, projects may be defined with large amounts of data requiring hours of time to effectively review to understand and evaluate the full scope of the proposal. Some donors may be highly motivated to review the entirety of a number of proposals whereas other donors do not have the skillset or motivation to do so. In either case, as the system may have hundreds and/or thousands of projects, identifying best-match projects is important to make the review/evaluation process possible.

In addition, as noted above, aiding the browsing process for donors is important for increasing the likelihood of funding a project.

The following definitions are utilized in describing the attributes used by the system by which donors are matched to projects.

The term “user attribute” is defined as an attribute of a user, in which for any given user, the user attribute is a field with a value interpretable by a computer and stored in the website platform's database.

The term “explicit attribute” is defined as a user attribute that is explicitly inputted by a user as a field that should be stored.

The term “implicit attribute” is defined as a user attribute that is determined by the user's activity on the website platform or, in some embodiments, other platforms.

For example, a potential donor may directly input their interests as stroke, aneurysms, and intravenous alteplase; that information would be stored as explicit attributes. If the user then interacts with proposals related to cancer treatment; that information would be at least initially stored as implicit attributes.

In one embodiment, as noted above, an implicit attribute may become an explicit attribute if, at some point, based on one or more implicit attributes a user is prompted (e.g., by email) to determine if an implicit attribute should become an explicit attribute and the user responds in such a way that an implicit attribute can updated to an explicit attribute.

A “proposal attribute” is a property of a research proposal that is gathered either through direct input from the research group or indirectly through a scraping software that searches the proposal for key elements. Typical properties would include the stage of the project (e.g., 5% funded vs. 80% funded), the proposal rating (based on other users), the size of the budget ($1,000 vs. $1,000,000), the number of users who have interacted with the proposal, and the number of times the proposal has been updated. Scraping software could infer other proposal attributes, such as the rareness of the topic being studied (e.g., cancer, which is very popular, versus PICA aneurysm, which is very rare) or the novelty of the research idea (compared against proposals on the platform and data scraped from other websites).

As introduced above, the system provides a method of matching donors to projects using both explicit and implicit attributes. The system continuously evolves as users (potential donors, donors and researchers) engage with the system. The system utilizes the accumulated information and relevant attributes to personalize and optimize the proposal-browsing experience of each user.

The general methodology is described through representative examples/situations that follows a potential donor called PD1 interacting with the system.

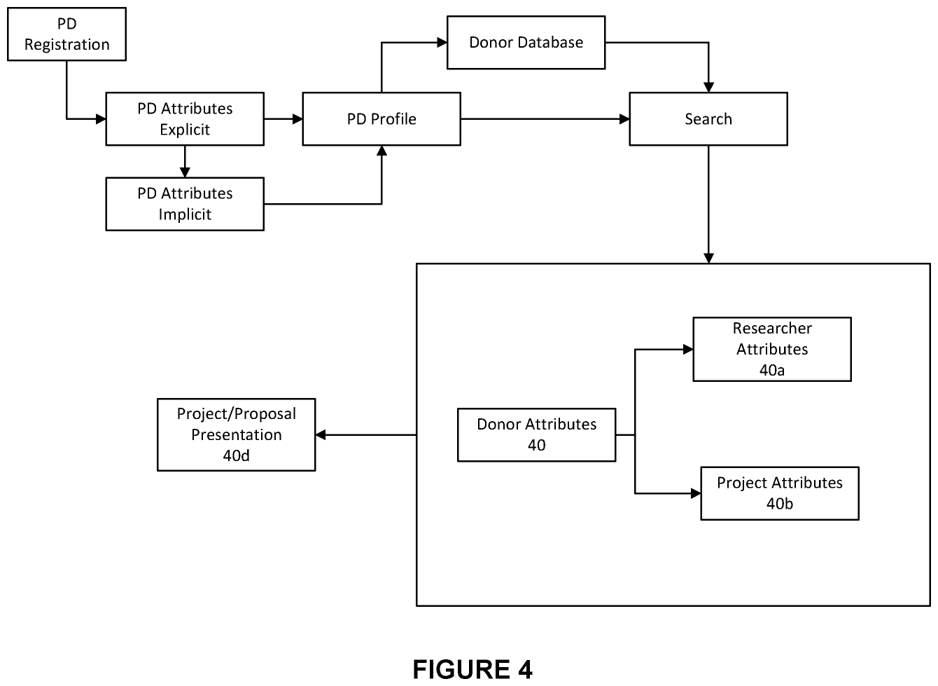

As introduced and as shown in FIGS. 3 and 4, the scenario of PD1 begins at a time in which the website platform is already well-established, with hundreds of thousands of users and thousands of projects and thousands of donations having been made. As such, the database of donors and researcher profiles is well-developed.

As shown in FIG. 3, PD1 begins registration 30a. In his registration, PD1 inputs their explicit attributes. By way of example, these include their age as 43, gender as male, country as Canada, city as Calgary, profession as CEO of Company, Inc., and interests as stroke, aneurysms, and endovascular thrombectomy. While PD1 does not have any professional experience in these areas of interest, he has an aunt who suffered from a stroke and was unsuccessfully treated using intravenous alteplase, and thus became interested in the development of stroke research. He also inputs to his Twitter and LinkedIn pages. Other attributes as described above may also have been input.

Using these explicit inputs, the website platform creates a donor profile 30b for PD1 that is initially defined by explicit attributes 30c. The donor profile may be updated by using scraping software to obtain implicit attributes 30d from his Twitter and LinkedIn activity. Such implicit attributes may be determined from their Twitter account, based on comments made on a news story reporting the successful Phase III approval of drug XYZ for cancer treatment. As such, while the donor may have indicated interest in strokes, it appears they may also be implicitly interested in cancer research.

The algorithm then compares PD1's existing explicit and implicit attributes to donors in the database 30f with similar attributes to determine those previous donors that have the most similar attributes to PD1 and the “behavior” of those previous donors. The previous donors in the database, who have more accumulated information than PD1 in the form of implicit attributes through their more extensive activity on the website platform, will serve as a basis for the type of proposals that would likely interest PD1.

In this case, the algorithm determines that Canadian males in their 40s generally sponsor projects with a Canadian PI, with additional preference for female PIs. It also determines that high-level executives prefer providing large lump-sum donations to proposals with higher budgets that have many prior donations. It also determines that donors with interests listed as intravenous alteplase generally do not fund proposals that focus on endovascular thrombectomy.

However, for the purposes of discussion, at this time, the majority of donors in the database have been only one-to-two-time donors. As such, while the algorithm identified the aforementioned patterns, the statistical confidence of making a “prediction” as to what interest PD1 is low given the relatively small amount of data from previous donors. That is, if the system were to rely solely on the above observed patterns based on the data in the database, the risk of presenting “uninteresting” projects to the potential donor becomes higher and the likelihood of eliciting a donation is lower.

As a result, the system utilizes two additional strategies defined herein as “negative matching” and “serendipity matching” to enhance the likelihood of matching a project that a donor may be genuinely interested in.

Negative matching is a process in which the algorithm recommends proposals to the potential donor that has one or more attributes that “oppose” what the algorithm gathered from the donor database. In the context of this description, the term “oppose” is defined in the context of system predictions. That is, over time, the system can determine that a PD having certain attributes may routinely or predicatively not make donations to projects that have certain project/researcher attributes. As such, the system has learned that it is unlikely, based on the past behaviors of a number of donors, that certain donors will donate to certain projects. As such, the system may identify projects that it would expect that a donor would not donate to. This type of project would then be considered a “negatively matched” project.

As noted, these attributes can be proposal attributes or user attributes from the proposal's research group. In this way, the potential donor will be exposed to ideas that the algorithm currently believes to be out of line with what the potential donor would desire in a proposal. In the case of PD1, as a negatively matched proposal he may be recommended a proposal with a female and Canadian PI, but with a focus on endovascular thrombectomy as a treatment for stroke. In this case, the algorithm is specifically negatively matching the interest attribute of PD1 by listing a proposal related to endovascular thrombectomy, which the algorithm currently believes to be in “opposition” of intravenous alteplase.

Serendipity matching is a process in which the algorithm recommends proposals to the potential donor somewhat haphazardly with the intention being to expose the potential donors to new fields and ideas and/or present projects that include different research attributes. In the case of PD1, randomly, he may be recommended a proposal from an Italian, female PI with a budget of US$10,000 with the topic of exploring the effects of playing a musical instrument on early on-set dementia. The degree to which this proposal aligns with what the algorithm currently believes to be PD1's ideal proposal is predominantly arbitrary, since the attributes in the proposal were chosen at random and may have zero or very few matching attributes. Importantly, “matching” can be conducted by a variety of techniques including neural networks, SVMs, logistical regression, etc.) and it is upon projects being chosen that information is learned (i.e. explicit behaviors) that will determine the relative degree of matching.

The continued interaction of PD1 with the system continues with reference to FIGS. 3-6 and describes processes by which the donor initially engages with the system (FIG. 3), reviews projects, makes a donation to a project and subsequently returns to the system to make further donations.

As shown in FIGS. 3 and 4, the system searches for proposal matches 30e based on the user attributes via a comparison of the new donor attributes to past donors' attributes to determine those donors that are most closely matched to PD1 and what proposals interested the past donors. Further, the search determines based on the PD1 attributes, that other donors having the closest match to PD1 donor attributes have a preference for donating to projects with certain researcher attributes 40a and proposal attributes 40b.

As shown in FIG. 4, the system determines that PD1 when compared to other donors is most closely aligned to research projects having researcher attributes 40a (e.g. researcher attributes of having a Canadian PI and a female PI) based on aligned donor attributes 40 (e.g. donor attributes being Canadian, male, in their 40's, being a high-level executive and interested in intravenous alteplase). Similarly, the system determines that for these donor attributes 40, donors having these attributes are most likely to donate to projects having proposal factors 40b (e.g. having a higher budget and having received many prior donations).

From this comparison, an initial list of research projects 40d is displayed to PD1 that based on the above attribute matching, the system believes align with PD 1's ideal proposal.

The list of proposals includes proposals that are believed to be aligned with the donor's interests as well as proposals that are negatively matched and serendipitously matched.

For example, in one embodiment, if 10 research proposals are presented, 6-8 may be presented as being understood to best align with the donor's interests, 1-2 are also presented as being negatively matched and 1-2 are presented as being serendipitously matched.

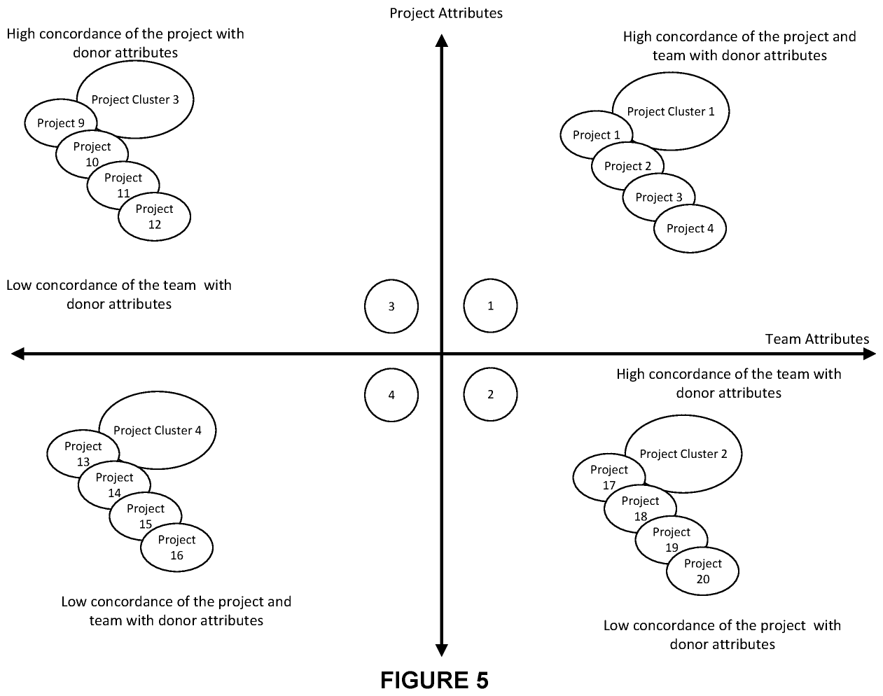

This is further described as shown in FIG. 5 which shows how projects may be characterized for presentation to a PD. FIG. 5 shows four quadrants where the relevance of projects are:
a. positively matched (quadrant 1 showing high concordance of the projects with donor attributes and research team attributes);
b. more strongly matched to research team attributes (quadrant 2 showing lower concordance of the projects with donor attributes and higher concordance to research team attributes);
c. more strongly matched to donor attributes (quadrant 3 showing high concordance of the projects with donor attributes and lower concordance to research team attributes); and,
d. poorly matched (quadrant 4 showing low concordance of the projects with donor attributes and research team attributes).

FIG. 5 illustrates that the system has determined that projects 1-4 are strongly matched to the PD's attributes (project cluster 1) whereas projects 17-20 (project cluster 2), projects 9-12 (project cluster 3) and projects 13-16 (project cluster 4) are less strongly matched to a PD's attributes as described above. Once the system has determined the various clusters, the system will emphasize presentation of cluster 1 projects together with a smaller percentage of cluster 2-4 projects being presented. Generally, cluster 4 projects are negatively matched projects whereas cluster 2 and 3 projects are serendipitously matched projects.

If PD1 donates to a project, the system will note whether the donation was made to a project that was aligned, negatively matched or serendipitously matched to PD1's attributes.

If a donation is made, the system tracks the donation and uses the information to update the implicit attributes for PD1.

If the project was characterized as aligned, and the donor subsequently returns to the website, the presentation of a second iteration of projects may present a higher proportion of aligned projects as the newly acquired implicit attribute of the donor has confirmed the earlier explicit attributes of the donor.

If the project was characterized as a negatively matched project, and the donor subsequently returns to the website, the presentation of a second iteration of projects may use this newly acquired implicit attribute of the donor from the first iteration to present a higher proportion of negatively matched projects during the second interaction.

For example, while it may have initially seemed that the donor attributes of PD1 would more likely have aligned with a research project that favored basic research as opposed to surgical procedures, PD1 selected and donated to a project that was a serendipitously-matched project where the PI was a female Canadian (which was aligned with PD1 researcher preferences), but with the focus was on endovascular thrombectomy as a treatment for stroke (which was not aligned with PD1's initial indication of interest in basic research).

It is noted that as the scope of the system grows, the system may also flag many other attributes relating to a project all of which may be taken into account when determining the relative alignment to a PD's interests.

Further, the relative weighting that may be applied to an implicit attribute may be determined by its relative position in an attribute hierarchy. That is, and as shown in Table 1 above, for a given PD profile, the PD may have entered explicit attribute data in 8 different attribute categories with dozens of individual fields of data having been entered as attributes and sub-attributes. Depending on the attribute category and/or the attributes, each may be assigned different weighting factors when looking to match projects where, for example, “sub-attributes” may be assigned lower weighting factors. In various embodiments, the weighting factor of PD1's implicit behavior in his initial profile can be based on the initial assumptions that the system made.

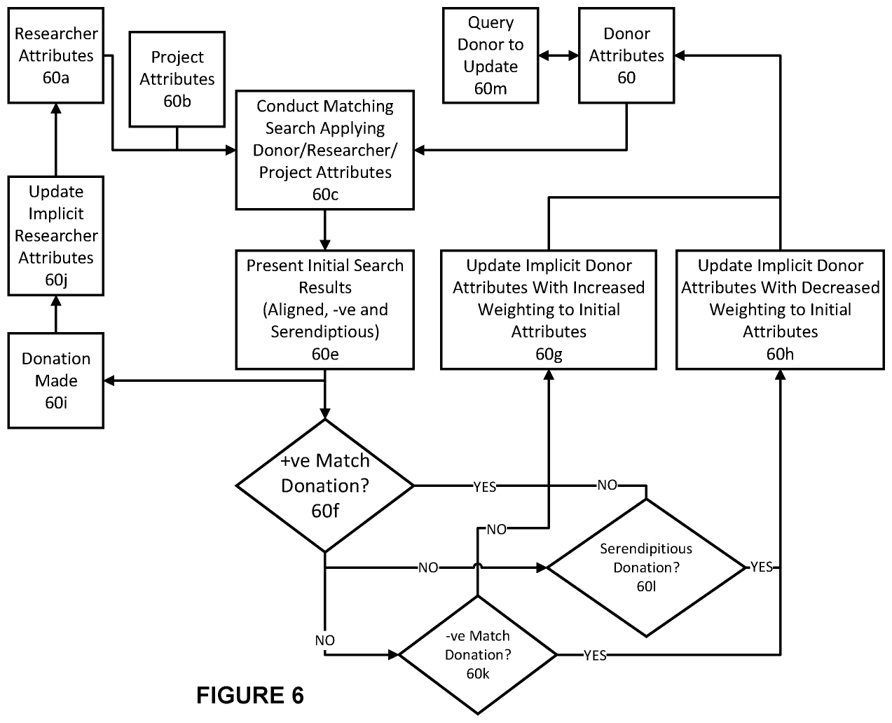

As shown in FIG. 6, as each donor interacts with the system, donor and researcher attributes may be updated based on the actions a donor has taken with the system. Initially, the system has donor attributes 60, researcher attributes 60a and project attributes 60b. A matching search 60c is conducted based on the donor 60, researcher 60a and project attributes 60b and results presented which includes a combination of aligned, negative and serendipitously matched projects 60e. If a positively matched project is donated to, implicit donor attributes are updated with increased weighting to initial donor attributes 60g. Alternatively, if a donation is made to negatively matched 60k or serendipitously matched 60l projects, implicit donor attributes are updated with decreased weighting to initial donor attributes 60h. If any donation is made 60i, implicit researcher attributes are updated 60j. Upon updated implicit attributes, the system may query donors to update explicit attributes 60m.

In summary, the weighting system can be implemented as follows:
a. the more an implicit behavior correlates to attributes that the algorithm deems strong predicting attributes, the more weight it will have in the subsequent interactions.
b. Among these strong predicting attributes, the more the behavior deviates from the prediction the algorithm made, the more weight it will have in the subsequent interactions.

Once each user profile has been updated, these updates are synthesized in the donor and researcher databases. Accordingly, PD1's profile updates will be sent to the donor database, and each research group member's profile updates will be sent to the researcher database. This will allow for the databases to communicate and match factors in future interactions.

Further, the algorithm does not “understand” the underlying reason why a negatively matched or serendipitously matched donation was made which ultimately could be based on any number of human factors or reasons.

For example, perhaps the reason that potential donors did not donate to endovascular thrombectomy was because they had not ever heard of the term, so they instinctively avoided it. Another alternative is that PD1 is an anomaly in the group of potential donors that are similar to him, and that, on average, this group would not donate to proposals related to endovascular thrombectomy, but PD1 would. Another alternative is that there is a more important factor that the algorithm is currently underweighting that is driving the difference between PD1's choice and the algorithm's prediction.

In the example used throughout this application, beyond the subject matter area of the project that was funded, the next highest weighted implicit behaviors that PD1 made in his donation was the personal information of the research group's PI. Unlike above, PD1's behavior of selecting a Canadian, female PI was in line with what the algorithm predicted. Thus, although the weight was strong, the algorithm “believes” that there does not need to be additional testing on this factor, unless future behavior suggests otherwise.

In one embodiment, the algorithm has a matching strategy that leans more towards serendipity than negative matching for those projects that are not the positively aligned project being presented.

Further, in various embodiments, the system looks to find any pattern at all rather than a pattern in particular. Accordingly, the system may employ the following strategy: have a proportion (e.g. 20%) of recommended projects relate to one technical area (e.g. dementia), another proportion (e.g. 15%) of recommended projects relate to another technical area (e.g. stroke treatment, both with a focus on intravenous alteplase and endovascular thrombectomy) to ensure some level of negative matching, and the remaining proportion (e.g. 65%) of projects be chosen completely through serendipity.

In various embodiments, the closer the user's attributes are to what the system predicted, the more the system will use regular/positive matching, with additional negative matching to refine the precision on particular, uncertain attributes. The further a user's attributes are to what the system predicted, the more the system will employ serendipity to attempt to pick up a trend, then further refine it with the previous process. Ideally, the system will always employ some degree of negative matching and serendipity to ensure that the algorithm is not overfitting and causing an echo chamber in its recommendations.

1. A system for matching user attributes of registered users of a database to projects within the database wherein each project has project attributes, comprising:
a non-transitory computer readable medium encoded with instructions to perform the following steps:
A1—defining a registered user record with a plurality of user attributes including explicit user attributes and at least one implicit user attribute within a user database;
A2—defining projects with a plurality of project attributes within a project database;
via a website interface and upon a registered user accessing the website interface to examine projects within the database
B1—conducting a matching search between explicit user attributes and project attributes to create a listing of projects having a best correlation of explicit user attributes and project attributes; and,
C1—displaying a list of projects from step B1 to the user via the website.

2. The system as in claim 1 further comprising step D1—enabling a registered user to select a project and make a financial contribution to support a specific project and wherein upon making a financial contribution to the specific project, at least one implicit attribute of a user is updated based on the specific project selected and the project attributes of the specific project.

3. The system as in claim 2 where when a plurality of registered users having each made at least one financial contribution to a project in the past, the system defines the plurality of registered users having each made at least one financial contribution to a project in the past as past donors, and the system, based on financial contributions made and project attributes, determines for the past donors, projects having a greater likelihood of eliciting a donation based on past activity of the past donors and projects having a lower likelihood of eliciting a financial contribution based on past activity of the past donors.

4. The system as in claim 3 where at least one project having a lower likelihood of eliciting a financial contribution is displayed to a user at step C1.

5. The system as in claim 1 further comprising step B1A—comprising the step of identifying at least one project having at least one randomly selected project attribute that is not aligned with a registered user's attributes for display to a user at step C1.

6. The system as in claim 1 further comprising step A3—defining a registered researcher record with a plurality of researcher attributes including explicit researcher attributes.

7. The system as in claim 6 further comprising step E1—enabling a registered user to select a project and make a financial contribution to support a specific project and wherein upon making a financial contribution to the specific project, updating a researcher's explicit attributes based on the specific project selected and the registered user attributes.

8. The system as in claim 7 further comprising step B1A—comprising the step of identifying at least one project having at least one randomly selected project attribute that is not aligned with a registered user's attributes for display to a user at step C1.
